(19) United States
(12) Patent Application Publication
(10) Pub. No.: US 2010/0201683 A1
(43) Pub. Date: Aug. 12, 2010

(54) MEDICAL IMAGE DISPLAY APPARATUS AND MEDICAL IMAGE DISPLAY METHOD

(76) Inventors: Takashi Shirahata, Tokyo (JP); Yuko Aoki, Tokyo (JP); Takashi Murase, Tokyo (JP)

Correspondence Address: COOPER & DUNHAM, LLP, 30 Rockefeller Plaza, 20th Floor, NEW YORK, NY, 10112, US

(21) Appl. No.: 12/671,477

(22) PCT Filed: Jul. 7, 2008
(86) PCT No.: PCT/JP2008/062258

§ 371 Date: Jan. 29, 2010

(30) Foreign Application Priority Data
Jul. 31, 2007 (JP) 2007 198344

(51) Int. Cl. G06T 17/00

(52) U.S. Cl. 345/420

(57) ABSTRACT

A medical image display apparatus that obtains medical image information of a real space coordinate system containing a luminal organ of an examinee and develops the thus-obtained medical image information of the real space coordinate system to display a developed image of the luminal organ on a display device is equipped with a developed image creator for rearranging the obtained medical image information of the luminal organ of the real space coordinate system to medical image information of the luminal organ of a developed image crating coordinate system by adding information about the radial direction of the luminal organ of the real space coordinate system to create a developed image, and a developed image display unit for displaying the created developed image.

### TECHNICAL FIELD

The present invention relates to a medical image display device for displaying a medical image obtained by a medical image pickup apparatus such as an X-ray CT apparatus, an MRI apparatus, an ultrasonic diagnosis apparatus or the like. Specifically, the present invention relates to a medical image display device for displaying a luminal organ represented by large intestine or blood vessel.

### BACKGROUND ART

In general, a medical image display device obtains a medical image from a medical image pickup apparatus such as an X-ray CT apparatus, an MRI apparatus, an ultrasonic diagnosis apparatus or the like, and subjects this medical image to image processing to display a diagnosis image such as a three-dimensional image or the like.

Furthermore, there is disclosed a developed image projection method of adding direction information representing the direction of a three-dimensional image with a developed image obtained by two-dimensionally developing a luminal organ in a three-dimensional image, whereby an observation direction or observation position of the developed image is intuitively grasped (for example, see [Patent Document 1]).

Patent Document 1: JP-A-2006-18606

### DISCLOSURE OF THE INVENTION

### Problem to be Solved by the Invention

However, the medical image display device of [Patent Document 1] has an unsolved problem that information about a radial direction of a luminal organ is added to display a developed image obtained by visualize the shape information of the inner wall of the luminal organ.

An object of the present invention is provide a medical image display apparatus and a medical image display program that visualize shape information of the inner wall of a luminal organ by adding information about a radial direction of a luminal organ, whereby a developed image obtained by visualize the shape information can be displayed.

### Means of Solving the Problem

According to the present invent invention, a medical image display apparatus that obtains medical image information in a real space coordinate system containing a luminal organ of an examinee and develops the thus-obtained medical image information in the real space coordinate system to display a developed image of the luminal organ on a display device is characterized by comprising a developed image creator for rearranging the obtained medical image information of the luminal organ of the real space coordinate system to medical image information of the luminal organ of a developed image crating coordinate system by adding information about the radial direction of the luminal organ of the real space coordinate system to create a developed image, and a developed image display unit for displaying the created developed image.

A medical image display method according to the present invention is characterized by comprising a step of obtaining medical image information in a real space coordinate system containing a luminal organ of an examinee by a medical image pickup apparatus, a step of rearranging the obtained medical image information of the luminal organ in the real space coordinate system to medical image information of the luminal organ of a developed image creating coordinate system by adding information of the radial direction of the luminal organ of the real space coordinate system, and a step of displaying the created developed image on an image display unit.

### EFFECT OF THE INVENTION

According to the present invention, there can be provided a medical image display apparatus and a medical image display method that can display a developed image obtained by adding information of the radial direction of the luminal organ and visualizing shape information of the inner wall of the luminal organ.

### BRIEF DESCRIPTION OF THE DRAWINGS

FIG. 1 is a diagram showing the hardware construction of a medical image display apparatus 1.

FIG. 2 is a functional block diagram of CPU 10.

FIG. 3 is a flowchart showing the operation of the medical image display apparatus 1.

FIG. 4 is a diagram showing a luminal organ 41 in medical image information 40.

FIG. 5 is a diagram showing a luminal area 45 of the luminal organ 41 in the medical image information 40.

FIG. 6 is a diagram showing medical image data 61 of the medical image information 40 in a real space coordinate system.

FIG. 7 is a diagram showing medical image data 71 of medical image information 70 in a developed image creating coordinate system.

FIG. 8 is a diagram showing an example of GUI 80 displayed on a display 19.

FIG. 9 is a diagram showing an example of GUI 90 displayed on the display 19.

FIG. 10 is a flowchart showing biomedical tissue information processing (step 3A of FIG. 3).

FIG. 11 is a diagram showing a developed image 112 displayed in a developed image display area 111 of GUI 110.

FIG. 12 is a flowchart showing shape information processing (step 3B of FIG. 3).

FIG. 13 is a diagram showing a developed image 132 displayed in a developed image display areas 131 of GUI 130.

FIG. 14 is a flowchart showing interest area processing (step 3C of FIG. 3).

FIG. 15 is a diagram showing a developed image 152 displayed in a developed image display area 151 of GUI 150.

FIG. 16 is a diagram showing a developed image 162 displayed in a developed image display area 161 of GUI 160.

FIG. 17 is a diagram showing a developed image 170 relating three axes of the developed image creating coordinate system (when the width in a T-axis direction varies).

FIG. 18 is a diagram showing a developed image 180 relating the three axes of the developed image creating coordinate system (when the width in the T-axis direction is fixed).

### DESCRIPTION OF REFERENCE NUMERALS

1 medical image display apparatus, 10 CPU, 11 medical image pickup apparatus, 12 LAN, 13 magnetic disk, 14 main memory, 15 controller, 16 mouse, 17 keyboard, 18 display memory, 19 display, 21 luminal organ core line extracting unit, 22 medical image data rearranging unit, 23 rotational center/rotational angle setting unit, 24 developed image creator, 25 biomedical tissue information calculator, 26 biomedical tissue information superposing unit, 29 interest area processor, 40 medical image information (real space coordinate system), 41 luminal organ, 42 core line, 61 medical image data (real space coordinate system), 70, 171, 181 medical image information (developed image creating coordinate system), 71 medical image data (developed image creating coordinate system), 80, 90, 110, 130, 150, 160 GUI, 81, 91, 111, 131, 151, 161 developed image display area, 82, 92, 112, 132, 152, 162 developed image, 170, 180 developed image relating to three axes of developed image creating coordinate system

### BEST MODES FOR CARRYING OUT THE INVENTION

Preferred embodiments according to the present invention will be hereunder described in detail with reference to the accompanying drawings. In the following description and the accompanying drawings, the constituent elements having the same functional constructions are represented by the same reference numerals, and the duplicative description thereof is omitted.

In the following embodiment, a CT image is used as a medical image, and the description will be made by citing an intestinal canal as a luminal organ of an observation target or diagnosis target. However, the present invention is not limited to the CT image. A medical image picked up by an MRI apparatus or an ultrasonic imaging apparatus may be used. Furthermore, luminal organs other than the intestinal canal, such as blood vessel, windpipe or the like can be the target.

### <Construction of Medical Image Display Apparatus 1>

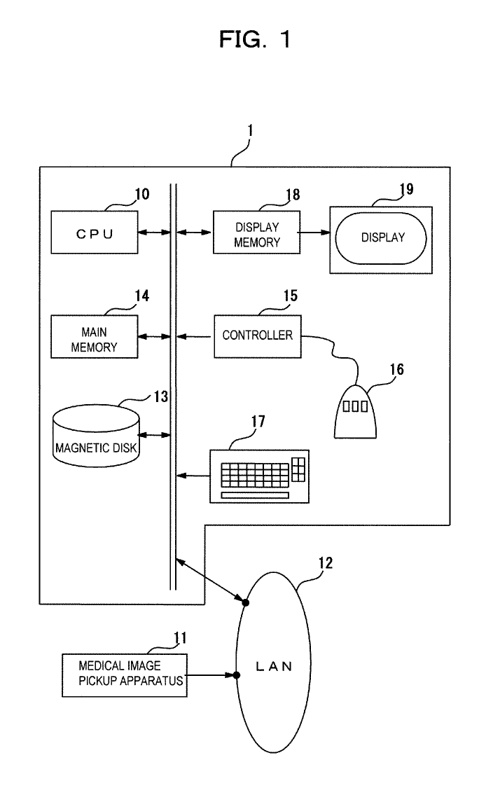

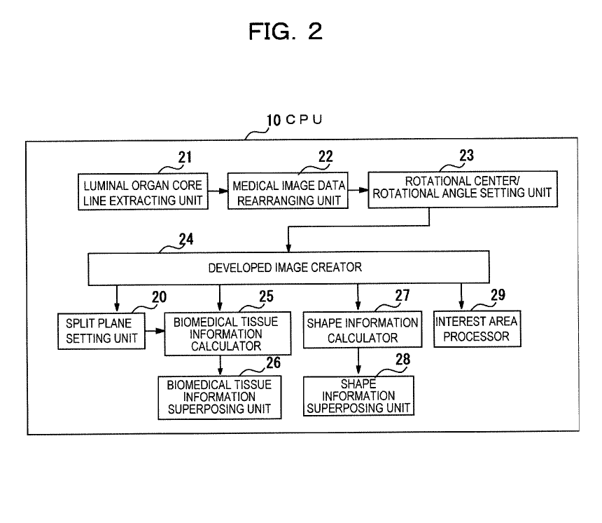

First, the construction of a medical image display apparatus 1 will be described with reference to FIGS. 1 and 2.

FIG. 1 is a diagram showing the hardware construction of the medical image display apparatus 1.

The medical image display apparatus 1 has CPU 10, a magnetic disk 13, a main memory 14, a mouse 16 or a keyboard 17 connected to a controller 15, a display memory 18 and a display 19. The medical image display apparatus 1 is connected to a medical image pickup apparatus 11 through LAN 12.

The medical image pickup apparatus 11 is an apparatus for picking up a medical image such as a tomogram or the like of an examinee. The medical image pickup apparatus 11 is an X-ray CT apparatus, an MRI apparatus or an ultrasonic imaging apparatus, for example. The medical image display apparatus 1 displays a medical image of the examinee. The “medical image” contains not only a medical image picked up by the medical image pickup apparatus 11, but also a two-dimensional medical image obtained by subjecting a medical image to image processing, for example, a pseudo three-dimensional image or a developed image.

CPU 10 is a device for controlling the operation of each connected constituent element. CPU 10 loads into the main memory 14 and executes programs stored in the magnetic disk 13 and data required to execute the programs stored in the magnetic disk 13. The magnetic disk 13 is a device for obtaining, through a network such as LAN 12 or the like, a medical image such as a tomogram or the like which is picked up by the medical image pickup apparatus 11, and stores the obtained medical image therein. Furthermore, programs to be executed by CPU 10 and data required to execute the programs are stored in the magnetic disk 13. The main memory 14 stores the programs to be executed by CPU 10 and intermediate step results of calculation processing. The mouse 16 and the keyboard 17 are operation devices through which an operator instructs the operation of the medical image display apparatus 1. The display memory 18 stores display data to be displayed on the display 19 such as a liquid crystal display, CRT or the like.

FIG. 2 is a functional block diagram of CPU 10.

CPU 10 has a luminal organ core line extracting unit 21, a medical image data rearranging unit 22, a rotational center/rotational angle setting unit 23, a developed image creator 24, a split plane setting unit 20, a biomedical tissue information calculator 25, a biomedical tissue information superposing unit 26, a shape information calculator 27, a shape information superposing unit 28 and an interest area processor 29.

The luminal organ core line extracting unit 21 extracts the core line of a luminal organ in a medical image. The medical image data rearranging unit 22 performs polar coordinate transformation at each point on the extracted core line of the luminal organ, and transforms the data arrangement from medical image data of a real space coordinate system to medical image data of a developed image creating coordinate system. The rotational center/rotational angle setting unit 23 sets the rotational center and the rotational angle of a developed image. The developed image creator 24 carries out rendering on the basis of the set rotational center and rotational angle by using the medical image data of the developed image creating coordinate system to create the developed image.

The split plane setting unit 20 sets a split plane to the developed image and displays it. The biomedical tissue information calculator 25 calculates a CT value or a pixel value representing biomedical tissue information of the inner wall of the luminal organ from the medical image data. The biomedical tissue information superposing unit 29 superposes the biomedical tissue information calculated by the biomedical tissue information calculator 25 with the developed image. The shape information calculator 27 calculates shape information concerning the shape of the inner wall of the luminal organ from the medical image data. The shape information superposing unit 28 superposes the shape information calculated by the shape information calculator 27 on the developed image. The interest area processor 29 sets an interest area in the developed image, and executes zoom display or rotational display on the interest area.

### First Embodiment

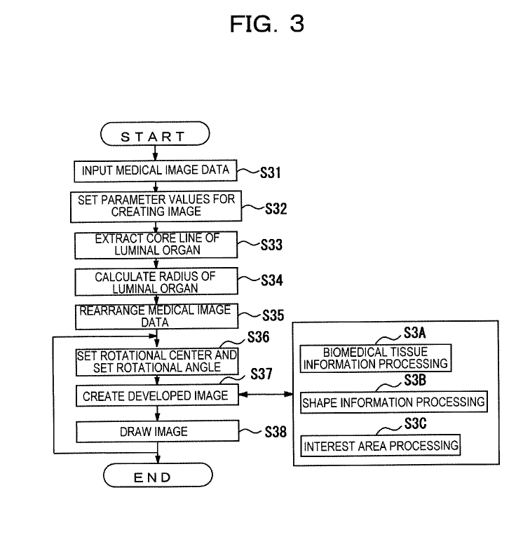

Next, a first embodiment will be described with reference to FIGS. 3 to 9.

FIG. 3 is a flowchart showing the operation of the medical image display apparatus 1.

### (Step 31)

An operator operates the mouse 16 and the keyboard 17 to select medical image information containing a luminal organ as an observation target or a diagnosis target from medical images picked up by the medical image pickup apparatus 11. The medical image information is volume image data obtained by piling up tomograms picked up by an X-ray CT apparatus, for example. CPU 10 of the medical image display apparatus 1 reads out the medical image information selected by the operator from the magnetic disk 13, and stores the medical image information into the main memory 14.

### (Step 32)

The operator operates the mouse 16 and the keyboard 17 to sets parameter values required for developed image creating processing. CPU 10 stores the parameter values set by the operator into the magnetic disk 13 or the main memory 14.

The parameter values contain threshold values in extraction of the core line of the luminal organ (step 33) and in calculation of the radius of the luminal organ (step 34), the size of a target area in the medical image data rearrangement processing (step 35) and a threshold value and opacity in the rendering operation in the developed image creation processing (step 37).

With respect to the parameter values, the operator may arbitrarily set them or parameter values which have been set in the medical image display apparatus 1 in advance may be used.

### (Step 33)

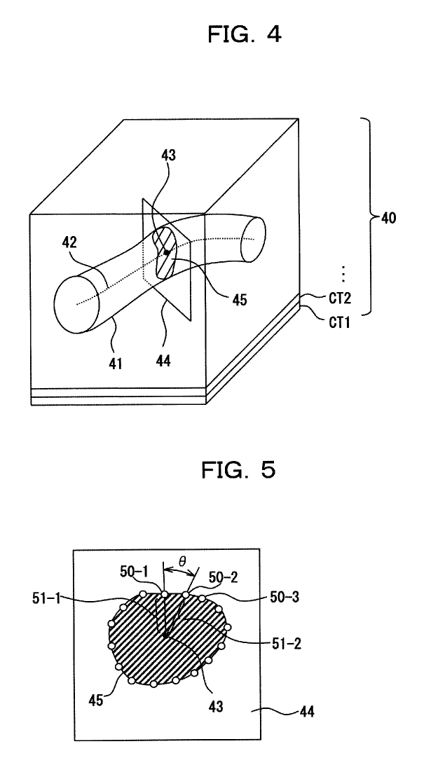

FIG. 4 is a diagram showing the luminal organ 41 in the medical image information 40.

CPU 10 (the luminal organ core line extracting unit 21) extracts the core line of the luminal organ 41 as a target from the medical image information 40. The method described in JP-A-2006-042969 may be used to extract the core line of the luminal organ. The medical image information 40 is three-dimensional medical image information in the real space coordinate system. For example, the medical image information 40 is volume image data obtained by piling up medical images CT1, CT2, . . . .

### (Step 34)

FIG. 5 is a diagram showing a luminal area 45 of the luminal organ 41 in the medical image information 40.

CPU 10 calculates the radius of the luminal organ 41 in a cross-sectional 44 perpendicular to the core line 42 at each point 43 on the core line 42 of the luminal organ 41 in the medical image information 40. The respective points 43 on the core line 42 are set at any sampling interval with respect to the core line 42 (for example, the size corresponding to one pixel of an input CT image).

The luminal area 45 is an area of the luminal organ 41 in the cross-section 44. With respect to the outer edge of the luminal area 45, it may be determined by threshold value processing using a threshold value set in the processing of the step 32. CPU 10 sets points 50-1, 50-2, . . . along the outer edge of the luminal area 45.

The radius 51-1, 51-2, . . . corresponds to a radial span connecting each of points 50-1, 50-2, . . . and the point 43. The intersecting angle between the adjacent radial spans 51 is an equal angle (θ). CPU 10 calculates the average value of the lengths of the radiuses 51-1, 51-2, . . . as the radius of the luminal organ 41 in the cross-section 44. Alternatively, CPU 10 creates a circle through approximation processing on the basis of the points 50-1, 50-2, . . . , and calculates the radius of this circle as the radius of the luminal organ 41 in the cross-section 44.

CPU 10 executes the same processing on each point 43 on the core line 42 to calculate the radius of the luminal organ 41.

### (Step 35)

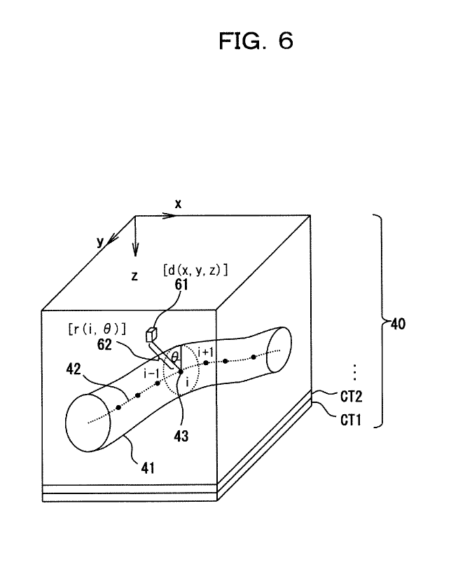

FIG. 6 is a diagram showing the medical image data 61 of the medical image information 40 in the real space coordinate system.

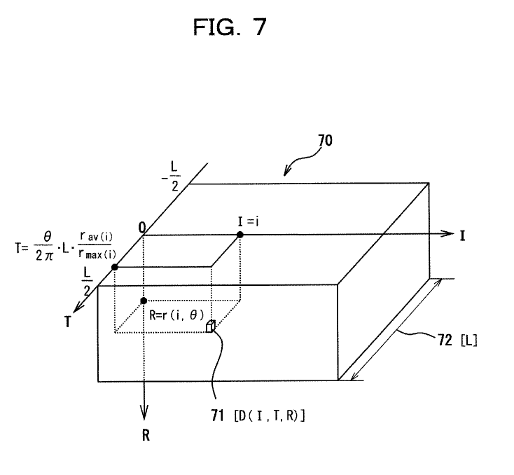

FIG. 7 is a diagram showing the medical image data 71 of the medical image information 70 in the developed image creating coordinate system.

The description will be described on the assumption that in the processing of the above step 34, CPU 10 calculates the average luminal radius [rav(i)] of the radiuses 51-1, 51-2, . . . as the radius of the luminal organ 41 at each point 43[i] on the core line 42. Furthermore, CPU 10 calculates the maximum luminal radius [rmax(i)] of the radiuses 51-1, 51-2, . . . .

CPU 10 (the medical image data rearranging unit 22) arranges medical image data 61 [d(x,y,z)] of the real space coordinate system of FIG. 6 on medical image data 71[D(I, T, R)] of the developed image creating coordinate system of FIG. 7, whereby the medical image information 40 of the real space coordinate system read out from the magnetic disk 13 into the main memory 14 is converted to the medical image information 70 of the developed image creating coordinate system.

The real space coordinate system of FIG. 6 is an orthogonal coordinate system represented by x-axis, y-axis and z-axis. The developed image creating coordinate system of FIG. 7 is a polar coordinate system represented by I-axis, T-axis and R-axis. The medical image data 61 [d(x,y,z)] of FIG. 6 are medical image data such as a CT value of the real space coordinate position (x, y, z), calculation value (pixel value, brightness value), etc. The medical image data 61[d(x,y,z)] is arranged in the medical image data 71[D(I, T, R)] at the developed image creating coordinate position (I, T, R) of FIG. 7.

Specifically, the real space coordinate position (x,y,z) of FIG. 6 and the developed image creating coordinate position (I, T, R) of FIG. 7 are associated with each other on the following condition:

I=

T=(θL/(2π))·(rav(i)/rmax(i)),

R=r(i,θ),

r(i,θ): the distance 62 between the point 43 and the medical image data 61,

L: the target area size 72 (constant), L≧πrmax(i)

Accordingly, the information about the radial direction of the luminal organ 41 of the real space coordinate system is added to the medical image information 70 of the developed image creating coordinate system. When there does not exist any medical image data of the real space coordinate position (x,y,z) corresponding to the developed image creating coordinate position (I, T, R), the medical image data may be created by interpolation processing.

Here, with respect to the θ direction of FIG. 6, the development may be performed by using the average luminal radius rav(i) and the maximum luminal radius rmax(i) at the point 43[i] on the core line 42 shown in FIG. 7 with “(θL/(2π))·(rav(i)/rmax(i))” set as an axis or with “θL/(2π)” set as an axis.

In the former case, the width of the luminal organ in the developed image varies dependently on the average luminal diameter [rav(i)], and thus distortion of the luminal organ in the developed image can be reduced. The distortion is more greatly reduced when the developed image is created with the R-axis direction set to the direction of sight line. On the other hand, in the latter case, the size in the T-axis direction of the luminal organ in the developed image is fixed. For example, when the developed image is created with the R-axis direction set to the direction of the sight line, the luminal organ is represented as a rectangle. An area of the same θ value in the θ direction is extracted on a straight line, and thus the relative positional relationship of the area to be noted is easily understandable.

### (Step 36)

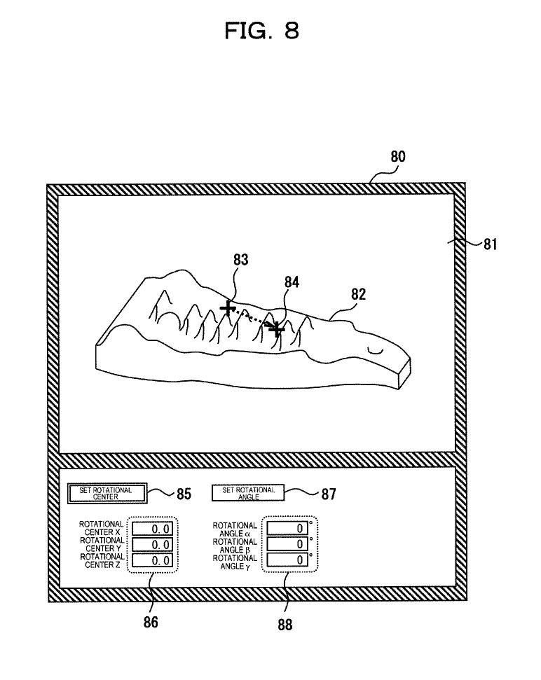

FIG. 8 is a diagram showing an example of GUI 80 (Graphical User Interface) displayed on the display 19. A developed image 82 of the luminal organ 41 is displayed in a GUI 80 developed image display area 81.

The operator interactively determines the rotational center and the rotational angle of the developed image 81 by using the input device such as the mouse 16, the keyboard 17 or the like on GUI 80. CPU 10 (the rotational center/rotational angle setting unit 23) sets the rotational center and the rotational angle of the developed image 82 on the basis of the input content of the operator.

When the rotational center is set, the operator indicates (clicks by the mouse 16) any position on the developed image display area 81 under the state that a rotational center setting button 85 is selected (under the state that it is pushed by the mouse 16). CPU 10 (the rotational center/rotational angle setting unit 23) moves the rotational center position from the position of an initial crisscross mark 83 to the position of an indicated crisscross mark 84. Furthermore, the operator may move the crisscross mark 83 to the position of the crisscross mark 84 by a drag operation of the mouse 16. Furthermore, the operator may set the coordinate of the rotational center by directly inputting a numerical value to a rotational center coordinate setting edit 86 on GUI 80.

When the rotational angle is set, the operator carries out the drag operation of the mouse 16 on the developed image display area 81 under the state that a rotational angle setting button 87 is selected (under the state that it is pushed by the mouse 16). CPU 10 (the rotational center/rotational angle setting unit 23) sets the rotational angle of the developed image 82 on the basis of the drag amount of the mouse 16.

Furthermore, the operator may set the rotational angle by directly inputting a numerical value into a rotational angle setting edit 88 on GUI 80.

When the rotational center and the rotational angle are changed by the operation of the mouse 16 on the developed image display area 81, the numerical values displayed on the rotational center coordinate setting edit 86 and the rotational angle setting edit 87 are changed interlocking with the above change.

### (Step 37)

CPU 10 (the developed image creator 24) read outs the medical image data 71 of the medical image information 70 created in the medical image data rearranging processing of the step 35 into the main memory 14. CPU 10 (the developed image creator 24) executes rendering on the rotational center and the rotational angle set in the processing of the step 36 by using the medical image data 71 of the medical image information 70. CPU 10 (the developed image creator 24) executes the developing processing and the projection processing, and executes the rotation processing on the basis of the rotational center and the rotational angle set in the processing of the step 36 to create the developed image 82 of the luminal organ 41.

### (Step 38)

CPU 10 inputs the image data of the developed image 82 created in the processing of the step 37 into the display memory 18, and displays the developed image 82 in the developed image display area 81 of GUI 80 displayed on the display 19.

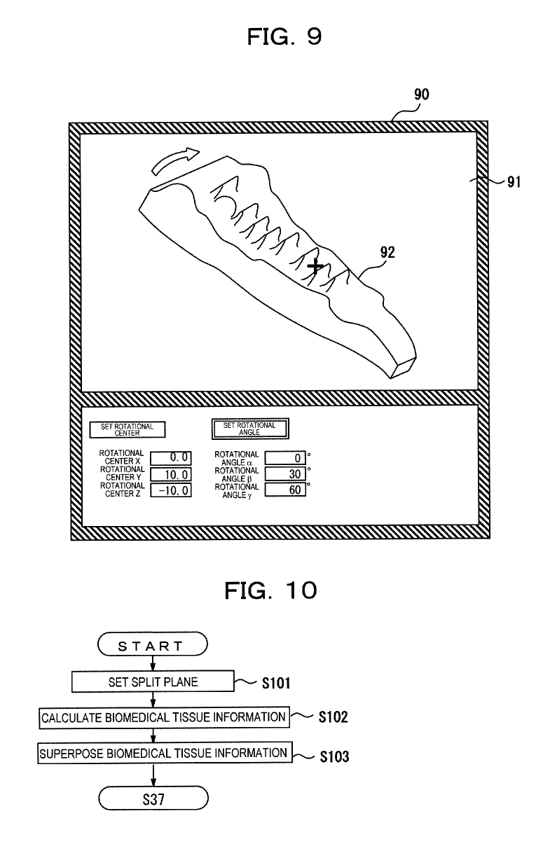

FIG. 9 is a diagram showing an example of GUI 90 displayed on the display 19. The developed image 92 of the luminal organ 41 is displayed in a GUI 90 developed image display area 91.

The operator changes the rotational center and the rotational angle of the developed image 81 by using the input device such as the mouse 16, the keyboard 17 or the like on GUI 90. CPU 10 (the rotational center/rotational angle setting unit 23) changes the rotational center and the rotational angle of the developed image 82 on the basis of the input content of the operator to renew the setting. CPU 10 repeats the processing of the step 36 to the step 38. CPU 10 rotates the developed image 82 of FIG. 8 on the basis of the newly set rotational center and rotational angle, and displays the developed image 92 in the developed image display area 91 of GUI 90 of FIG. 9.

As described above, in the first embodiment, the medical image display apparatus 1 displays the developed image 82 of the luminal organ 41 at any rotational center and rotational angle. The medical image display apparatus 1 can display the developed image of the luminal organ not only in a fixed direction, but also various directions as the direction of the sight line. Accordingly, the surface shape of the luminal organ such as polyp or the like can be observed with high precision, and thus oversight of a lesion is reduced, so that the recognition precision and diagnosis performance of the inner wall of the luminal organ and the can be enhanced.

In the processing of the step 37, the rendering method which CPU 10 (the developed image creator 24) executes by using the medical image data 71 of the medical image information 70 may be selected in accordance with the purpose. For example, surface rendering, volume rendering, a ray-sum method, a rendering method of MIP (Maximum Intensity Projection) may be used. In the surface rendering, the surface shape of the inner wall of the luminal organ 41 can be quickly displayed. In the volume rendering, the wet condition or inner structure concerning a biomedical tissue of the luminal organ 41 can be recognizably displayed, and a lesion progress level or benign and malignant lesions can be determined. Furthermore, an area of a blood vessel or the like around a lesion can be easily extracted by using the ray-sum method or the MIP method, and a diagnosis containing a blood flow condition of a nutrient vessel to a tumor or the like can be performed.

Furthermore, the medical image data rearranging processing may be executed every time a target range in a CT image is indicated.

### Second Embodiment

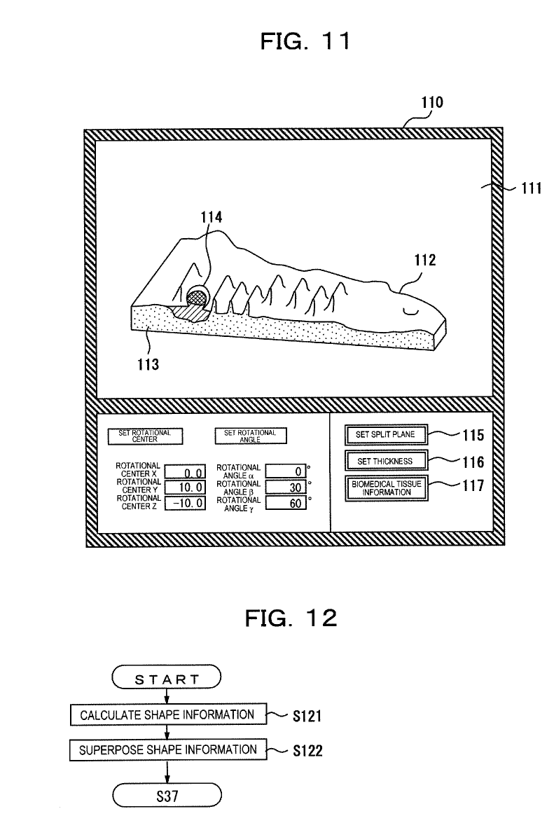

Next, a second embodiment will be described with reference to FIGS. 10 and 11.

FIG. 10 is a flowchart showing biomedical tissue information processing (step 3A of FIG. 3).

FIG. 11 is a diagram showing a developed image 112 displayed in a developed image display area 111 of GUI 110.

### (Step 101)

An operator indicates the position of a split plane 113 of the developed image 112 by using an input device such as a mouse 16, a keyboard 17 or the like, and clicks a split plane setting button 115 by the mouse 16. CPU 10 (the split plane setting unit 20) sets the split plane 113 in the developed image 112 on the basis of the input content of the operator. When the rendering is executed in the developed image creating processing of the step 37, CPU 10 (the developed image creator 24) creates the developed image so that a virtual beam (ray) for projection processing for an area to be displayed in front of the split plane 113 is transmitted through the area by 100%, and displays the split plane 112.

### (Step 102)

The operator clicks a biomedical tissue information button 117 by the mouse 16. CPU 10 (the biomedical tissue information calculator 25) calculates the biomedical tissue information such as a CT value or the like on the split plane 113 by using the medical image information 70 created in the medical image data rearranging processing of the step 35. The biomedical tissue information is not limited to only the CT value at the position of the split plane 113. CPU 10 (biomedical tissue information calculator 25) may make the split plane 113 have a thickness of several pixels in the vertical direction, and calculate the maximum CT value or minimum CT value in the thickness direction, or an integration value or average value of CT values in the thickness direction as biomedical tissue information. The operator clicks a thickness setting button 116 to input information concerning the thickness direction of the split plane 113.

### (Step 103)

CPU 10 (the biomedical tissue information superposing unit 26) superimposes the biomedical information calculated in the processing of the step 102 on the split plane 113 of the developed image 112 created in the developed image creating processing of the step 37 and displayed. For example, as shown in FIG. 11, the biomedical tissue information is displayed in a gray scale display (shading display) while superposed on the split plane 113 of the developed image 112. The operator refers to this superposition display to check the biomedical tissue information, etc. in a lesion site 114.

As described above, according to the second embodiment, the developed image of the luminal organ can be displayed while not only a fixed direction, but also various directions are set as the direction of the sight line as in the case of the first embodiment, and thus the recognition precision and the diagnosis performance of the inner wall of the luminal organ can be enhanced. Furthermore, according to the second embodiment, the shape of the lesion site such as polyp or the like can be clearly extracted, and also the wet condition, the state of the blood vessel around the lesion site, etc. can be observed from the biomedical tissue information such as the CT value, etc., so that the diagnosis performance can be further enhanced.

### Third Embodiment

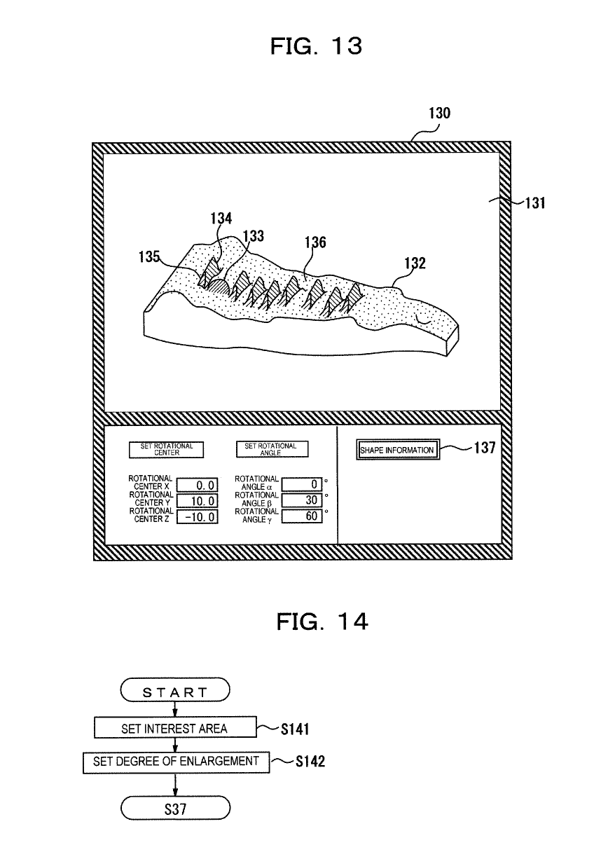

Next, a third embodiment will be described with reference to FIGS. 12 and 13.

FIG. 12 is a flowchart showing shape information processing (step 38 of FIG. 3).

FIG. 13 is a diagram showing a developed image 132 displayed in a developed image display area 131 of GUI 130.

### (Step 121)

The operator clicks a shape information button 137 by the mouse 16. CPU 10 (the shape information calculator 27) calculates the shape information concerning the surface shape of the inner wall of the luminal organ 41 by using the medical image information 70 created in the medical image data rearranging processing of the step 35. The shape information is a shape feature amount defining the surface shape of the inner wall of the luminal organ 41. For example, normal vectors may be obtained at respective points on the surface of the inner wall of the luminal organ 41, and the degree of concentration of these vectors may be used as the shape information.

### (Step 122)

CPU 10 (the shape information superposing unit 28) superposes the shape information calculated in the processing of the step 121 on the developed image 132 created in the developed image creating processing of the step 37, and displays them. As shown in FIG. 13, the shape information is displayed in a color mode while superposed on the developed image 132. A lesion site 133, the side surfaces 134 and 135 of crimps and a flat portion 136 are displayed with different colors because they have different surface shapes. For example, CPU 10 (the shape information superposing unit 28) superposes red color on an area having a high degree of concentration of calculated normal vectors calculated as the shape information in the processing of the step 121 and also superposes blue color in an area having a low degree of concentration of the normal vectors.

When the shape information is superposed and displayed in a color mode in the processing of the step 122, a color reference table for coloring processing is set in the processing of the step 32 of FIG. 3. CPU 10 (the shape information superposing unit 28) refers to the color reference table in the processing of the step 122 to execute coloring processing.

As described above, according to the third embodiment, the developed image of the luminal organ can be displayed while not only a fixed direction, but also various directions are set as the direction of the sight line as in the case of the first embodiment, and thus the recognition precision and the diagnosis performance of the inner wall of the luminal organ can be enhanced. Furthermore, according to the third embodiment, the shape of the lesion site such as polyp or the like is clearly visualized, and also the shape information of the inner wall of the luminal organ is superposed on the developed image in a color display mode, whereby the recognition precision of the surface shape and the diagnosis performance can be further enhanced.

### Fourth Embodiment

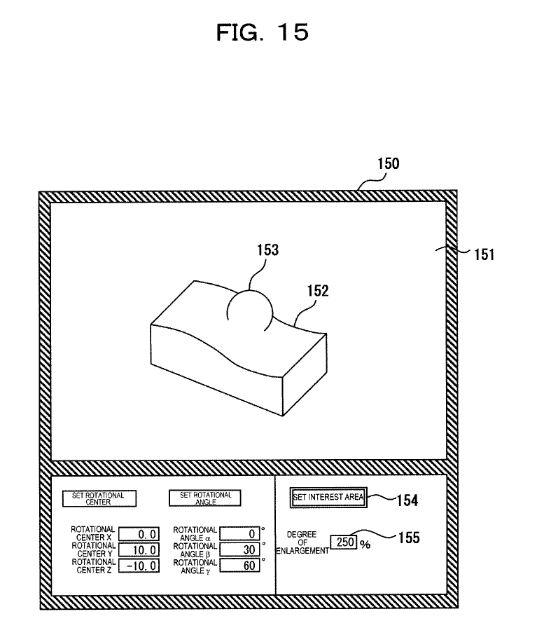

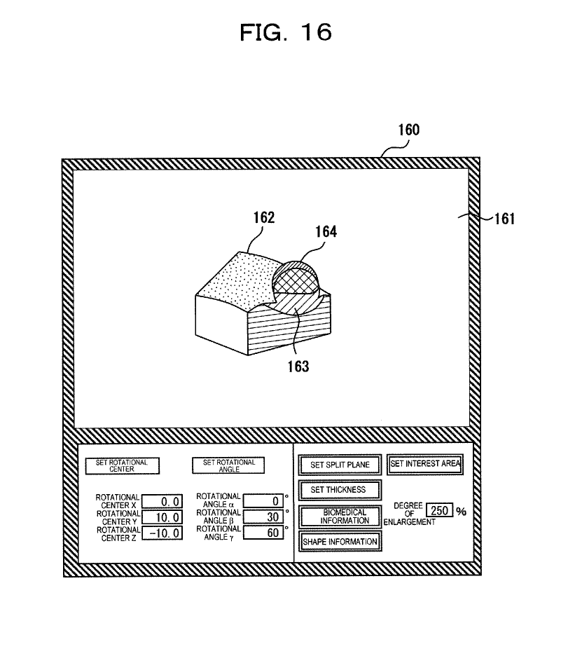

Next, a fourth embodiment will be described with reference to FIGS. 14 and 15.

FIG. 14 is a flowchart showing interest area processing (step 3C of FIG. 3).

FIG. 15 is a diagram showing a developed image 152 displayed in a developed image display area 151 of GUI 150.

### (Step 141 and Step 142)

The operator clicks an interest area setting button 154 by the mouse 16, and sets an interest area to be observed in detail and a scale of enlargement. The operator interactively sets the interest area and the scale of enlargement by using the input device such as the mouse 16, the keyboard 17 or the like while watching the developed image 152 displayed in the developed image display area 151 of GUI 150. With respect to the setting of the interest area, it may be performed by deforming a rectangular frame or surrounding a desired area through the drag operation of the mouse 16. With respect to the setting of the scale of enlargement, it may be performed by directly inputting a numerical value into a degree-of-enlargement setting edit 155 on GUI 150 or by using a preset value.

CPU 10 (the interest area processor 29) cuts out an interest area set in step 141 from the developed image created in the developed image creating processing of the step 37, enlarges the interest area with the degree of enlargement set in step 142, and displays the developed image 152 in the developed image display area 151 of GUI 150. As shown in FIG. 15, in the developed image 152, the interest area is set in the lesion site 153 and displayed in an enlarged display mode.

As described above, according to the fourth embodiment, the developed image of the luminal organ can be displayed while not only a fixed direction, but also various directions are set as the direction of the sight line as in the case of the first embodiment, and thus the recognition precision and diagnosis performance of the inner wall of the luminal organ can be enhanced. Furthermore, according to the fourth embodiment, the interest area is enlarged and rotationally displayed, whereby the recognition precision and diagnosis performance of the inner wall of the luminal organ can be further enhanced. Furthermore, the size of the interest area and the diameter of a projecting portion, etc. in the interest area may be simultaneously displayed. Still furthermore, the medical image data rearranging processing of the step 35 may be executed every time an interest area is set.

### (Others)

The first to fourth embodiment have been described above, and the medical image display apparatus 1 may be constructed by suitably combining these embodiments.

FIG. 16 is a diagram showing a developed image 162 displayed in a developed image display area 161 of GUI 160. FIG. 16 shows the developed image 162 when the first to fourth embodiments are applied.

The developed image 162 is a developed image for which a split plane and an interest area are set and enlarged display and rotational display are executed. Furthermore, biomedical tissue information and shape information are displayed with being superposed on the developed image 162. As shown in FIG. 16, the biomedical tissue information is displayed in a gray scale display mode or the like while superposed on a split plane area 163 of a lesion site. The shape information is displayed in a color display mode or the like while superposed on a surface area 164 of the lesion site.

### Fifth Embodiment

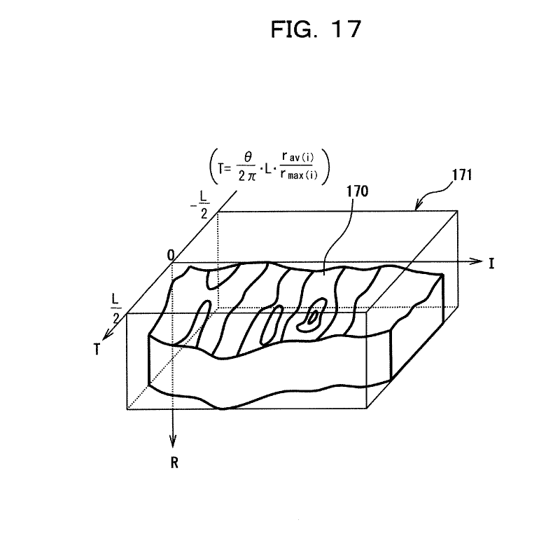

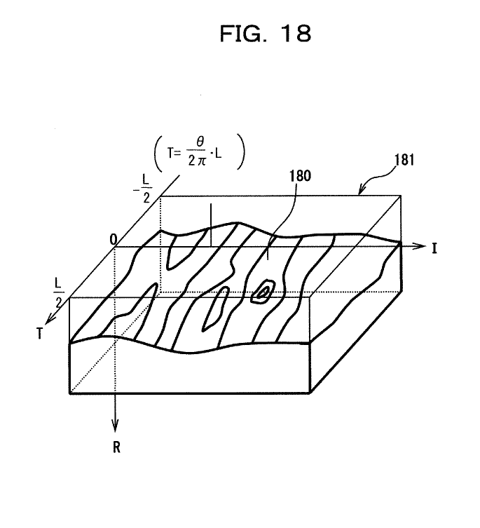

Next, a fifth embodiment will be described with reference to FIGS. 17 and 18.

FIGS. 17 and 18 are diagrams showing a developed image 170 and a developed image 180 concerning three axes of a developed image creating coordinate system, respectively.

In the first to fourth embodiments, the developed image creator 24 of the medical image display apparatus 1 creates the developed image two-dimensionally by using the medical image information in the developed image creating coordinate system. However, in the fifth embodiment, the developed image is three-dimensionally created by using medical image information in the developed image creating coordinate system.

As shown in FIGS. 17 and 18, the developed image creator 24 of the medical image display apparatus 1 creates the developed image 170 or developed image 180 based on the (I, T, R) display concerning the three axes of I-axis, T-axis and R-axis by using medical image information 171 or medical image information 181 of the developed image creating coordinate system.

FIG. 17 shows a case where the width in the T-axis direction of the developed image 170 varies in accordance with the average luminal radius [rav(k)]. That is, T=(θL/(2π))·(rav(i)/rmax(i)) is satisfied. FIG. 18 shows a case where the width in the T-axis direction of the developed image 180 is equal to a fixed value (L). That is, T=(θL/(2π) is satisfied.

As described above, according to the fifth embodiment, the developed image concerning the three axes of the developed image creating coordinate system is displayed, whereby the surface shape of the inner wall of the luminal organ can be displayed in detail. Particularly, the developed image concerning the three axes of the developed image creating coordinate system contains the information in the radial direction (R-axis direction) of the luminal organ, and thus the asperity of the inner wall of the luminal organ can be displayed in detail.

With respect to the developed image concerning the three axes of the developed image creating coordinate system, it can be displayed with various directions set as the direction of sight line by performing the rotation processing as in the case of the first to fourth embodiments.

The preferred embodiments of the medical image display apparatus according to the present invention have been described above. However, the present invention is not limited to the above embodiments. It is apparent that persons skilled in the art can make various kinds of modifications and alterations within the scope of the technical idea disclosed in the present application, and it is understood that they belong to the technical scope of the present invention.

1. A medical image display apparatus that obtains medical image information in a real space coordinate system containing a luminal organ of an examinee and develops the thus-obtained medical image information in the real space coordinate system to display a developed image of the luminal organ on a display device, characterized by comprising a developed image creator for rearranging the obtained medical image information of the luminal organ in the real space coordinate system to medical image information of the luminal organ in a developed image crating coordinate system by adding information about the radial direction of the luminal organ in the real space coordinate system to create a developed image, and a developed image display unit for displaying the created developed image.

2. The medical image display apparatus according to claim 1, wherein the developed image creator rearranges medical image information of the luminal organ of the real space coordinate system to medical image information in the luminal organ in the developed image creating coordinate system on the basis of a longitudinal axis direction of the luminal organ in the real space coordinate system and a peripheral direction and a radial direction of the luminal organ in the real space coordinate system.

3. The medical image display apparatus according to claim 2, wherein the longitudinal axis direction of the luminal organ of the real space coordinate system corresponds to the direction of a core line as a central line of the luminal organ extracted from the medical image information in the real space coordinate system.

4. The medical image display apparatus according to claim 1, further comprising a rotational center/rotational angle setting unit for setting a rotational center and a rotational angle of the developed image, wherein the developed image creator creates a rotated developed image obtained by rotating the developed image on the basis of the set rotational center and rotational angle by using the medical image information of the developed image creating coordinate system created by the medical image data rearranging unit.

5. The medical image display apparatus according to claim 1, wherein the developed image creator varies the width of the luminal organ in the developed image creating coordinate system in accordance with the radius of the luminal organ in the real space coordinate system.

6. The medical image display apparatus according to claim 1, wherein the developed image creator maintains the width of the luminal organ constant in the developed image creating coordinate system.

7. The medical image display apparatus according to claim 1, wherein the developed image creator converts data arrangement from the medical image information in the real space coordinate system to the medical image information in the developed image creating coordinate system every time a target range is indicated in the medical image information in the real space coordinate system.

8. The medical image display apparatus according to claim 1, wherein the developed image creator calculates biomedical tissue information concerning a biomedical tissue of the luminal organ from the medical image information in the developed image creating coordinate system, and superposes the biomedical tissue information on the developed image.

9. The medical image display apparatus according to claim 1, further comprising a split plane setting unit for setting a split plane of the luminal organ, wherein the developed image creator calculates the biomedical tissue information on the basis of the medical image information on the developed image creating coordinate system located on the set split plane, and superposes the biomedical tissue information on the split plane on the developed image.

10. The medical image display apparatus according to claim 1, further comprising a split plane setting unit for setting a split plane of the luminal organ, wherein the developed image creator calculates the biomedical tissue information on the basis of the medical image information in the developed image creating coordinate system located on the set split plane and around the split plane, and superposes the biomedical tissue information on the split plane on the developed image.

11. The medical image display apparatus according to claim 1, wherein the developed image creator calculates shape information characterizing the surface shape of the luminal organ from the medical image information in the developed image creating coordinate system, and superposes the shape information on the developed image.

12. The medical image display apparatus according to claim 1, further comprising an interest area setting unit for setting an interest area of the luminal organ, wherein the developed image creator executes at least one of enlargement processing and rotation processing on the set interest area to create the developed image.

13. The medical image display apparatus according to claim 1, wherein the developed image creator executes developing projection processing by using at least any one rendering method of surface rendering, volume rendering, a ray-sum method and MIP.

14. The medical image display apparatus according to claim 1, wherein the developed image creator creates a developed image concerning any three axes of the developed image crating coordinate system or three axes one of which contains a coordinate axis corresponding to the radial direction of the luminal organ in the real space coordinate system.

15. A medical image display method, characterized by comprising:
a step of obtaining medical image information in a real space coordinate system containing a luminal organ of an examinee by a medical image pickup apparatus;
a step of rearranging the obtained medical image information in the luminal organ of the real space coordinate system to medical image information of the luminal organ in a developed image creating coordinate system by adding information of the radial direction of the luminal organ of the real space coordinate system; and
a step of displaying the created developed image on an image display unit.
